(19) United States
(12) Patent Application Publication
(10) Pub. No.: US 2017/0197891 A1
(43) Pub. Date: Jul. 13, 2017

(54) QUANTUM CARRIER FOR IMPROVING SOIL FUNCTION AND METHOD OF PREPARATION THEREOF

(71) Applicant: Sanho Agricultural Energy Technology Ltd., New Taipei (TW)

(72) Inventor: Ju-Mei Huang, New Taipei (TW)

(73) Assignee: Sanho Agricultural Energy Technology Ltd., New Taipei (TW)

(21) Appl. No.: 14/991,592

(22) Filed: Jan. 8, 2016

(51) Int. Cl. C05G 3/02; C05D 3/02; C09K 17/00; C05G 3/00; A01G 1/00; A01N 59/06; A01N 25/12

(52) U.S. Cl. CPC C05G 3/02; A01N 59/06; C05D 3/02; A01N 25/12; C05G 3/0005; A01G 1/001; C09K 17/00

(57) ABSTRACT

A quantum carrier for improvement of soil functions and method of preparation thereof, the method of preparation includes crushing the oyster shell before subjecting to a first high temperature sintering at the temperature of between 800 and 1300° C. for between 1.5 and 2.5 hour, followed by mixing with diatomaceous earth, soil and water to form a liquid oyster shell liquid for liquid sintering at a temperature of between 800 and 1300° C. for between 7 and 9 hours, to give a dimpled or honeycomb-like particle with rough surface, the quantum carrier; the quantum carrier obtained by said method has the function of soil improvement, soil improvement includes self-purification of the soil, degradation of the heavy metals and toxin residues in the contaminated soil, water content increase, oxygen content increase, protein content increase, pH adjustment, pest elimination and promotion of microbial growth.

### BACKGROUND OF THE INVENTION

1. Field of the Invention

The present invention relates to a quantum carrier for improving soil functions and method of preparation thereof. In particular, the invention relates to a quantum carrier made of oyster shell powder that has the function of self-purification of the soil and can increase water content, oxygen content and protein content, adjust pH value, eliminate pests and promote microbial growth.

2. Description of the Prior Art

Since the 1970's, organic agriculture has sprung into widespread use as a production system for sustaining the soil, ecosystem and human health. The general requirements of organic farming are production and processing of agricultural products without the use of non-natural substances such as pesticides, chemical fertilizers, genetically modified organisms, animal and plant growth regulating agents. Meanwhile, most technologies that are currently used in organic agriculture usually supply the soil with excess fertilizers resulting in soil acidification and soil compaction. Moreover, organic fertilizers made of biological wastes produced by the husbandry industry through improper breeding may also cause secondary pollution due to heavy metal residues, which subsequently inhibits the growth of microorganisms in the soil and reduces the profits of the industry because of the high cost and low return of organic farming technology.

In the past, methods of removing the heavy metals in the soil include soil remixing, use of chemical additives and biological removal: (1) soil-turning method switches the clean dirt at the bottom with the contaminated soil on the surface so as to dilute the heavy metals in the soil; however, soil remixing is labor-intensive and merely dilutes, but does not remove, the heavy metals in the soil and may lead to larger scope of contamination; (2) use of chemical soil additivies reduces the activities of the heavy metals in the soil but large amount of chemicals will adversely impact soil element balance, eco-balance and the soil pH; and (3) biological removal whereby growing plants in the heavy metal-contaminated soil to remove the contaminated substances by the strong absorbance properties of plants employs take natural soil inhabitants such as worms to metabolite heavy metals or use microorganisms to improve the soil by mass production of microorganisms capable of eliminating heavy metals; thus, addition of such microorganisms to the contaminated soil helps reduce the amount of heavy metals in the soil. Unfortunately, however, biological removal is ineffective for removal of seriously contaminated soil. Moreover, the native strains may be adversely impacted because foreign organisms are in large quantities and may lead to biological crises.

To elevate the number of microorganisms for biologic removal of heavy metals and other unwanted soil pollutants, conventional methods of increasing soil microorganisms in the soil typically addi microbial strains, addition of bacterial strains can only temporarily increase the number of microorganisms in the soil. Moreover,such additions also has a number of contraindications, including (1) low survival rate of microorganisms cultured in the lab due to their inability to adapt to the field, (2) the added non-indigenous bacterial strains will compete with the native bacterial strains and cause imbalance of the microorganism flora and destroy microbial diversity of the ecosystem, (3) large amounts of non-indigenous strains may antagonize the native harmful strains fails, thereby stimulating the native harmful strains to evolve.

Wind, rain and sun all are the methods for purification of the soil to restore the normal physical and chemical environment of the soil, and soil will establish good microorganism flora under a good physical and chemical environment. Yet, the purification of wind, rain and sun is rather a slow process, for example, the cadmium contamination incident in Changhua County has been discovered for more than 30 years and the heavy metal remains in the soil and has not been eliminated.

Therefore, the need persists for an organic method to improve the soil function by self-purification, including removal of heavy metals and pesticide residues in the contaminated soil while adjusting the pH of the soil and providing a rich agricultural environment for microbial growth without chemical additive and restraint from use of non-indigenous bacterial strains so as to restore the native microorganism flora and soil quality..

### SUMMARY OF THE INVENTION

Addressing such and other drawbacks in prior art soil enhancement systems, the present invention provides a quantum carrier which thereby physically purifies the soil by eliminating heavy metals, pesticides and chemical fertilizers in the soil and provides a suitable environment for microbial growth. The quantum carrier according to the present invention is produced by liquid sintering of oyster shell powder, diatomaceous earth, deep soil and water. The convergent soil enhancement of this combination is provided by the confluence of properties of the constituents thereof. This is provided by the oyster shell powder heavy metal absorption capacity, diatomaceous earth pest elimination effect, and quantum carrier release of infrared light to increase the water content, oxygen content, protein content in the soil or adjust the soil pH to promote microbial growth.

The present invention further provides a method for preparation of a quantum carrier which is capable of improving soil function, comprising the following steps:
(1) Pre-sintering treatment: crushing the oyster shell into powder after cleaning the oyster shell to prepare a crushed oyster shell;
(2) First high temperature sintering: the crushed oyster powder is subjected to the first high temperature sintering, the sintering temperature is 800˜1300° C. and the sintering time is 1.5˜2.5 hours;
(3) Preparation of sintered oyster shell powder: the crushed oyster shell is grounded to sintered oyster shell powder after the first high temperature sintering;
(4) Mixing sintered oyster shell powder, diatomaceous earth and deep soil to prepare an oyster shell powder solid mixture; said oyster shell powder solid mixture is then mixed with water to form an oyster shell powder liquid mixture; said oyster shell powder liquid mixture consists of one part of the oyster shell powder solid mixture and 25˜35 parts of water;
(5) Subsequent high temperature sintering, wherein said oyster shell powder liquid mixture is subjected to high temperature sintering, said second high temperature sintering is liquid sintering, the temperature is 800 to1300° C. and sintering time is 7 to 9 hours to give a honeycomb-like particle with rough surface, the quantum carrier.

According to a preferred embodiment of the present invention, the diameter of said crushed oyster shell is less than 1 cm.

According to the invention, the preferred temperature for the first high temperature sintering is 1200° C. and the preferred sintering time for said first high temperature is 2 hours.

According to the invention, the diameter of said crushed oyster shell is between 40 and 400 mesh and diameter of 400 mesh is preferred.

According to a preferred embodiment of the invention, said solid oyster shell mixture is consisting of 8 to 12% of sintered oyster shell powder, to 12% of diatomaceous earth and 76 to 84% of deep soil.

According to a preferred embodiment of the invention, solid oyster shell mixture is consisting of 10% of sintered oyster shell powder, 10% of diatomaceous earth and 80% of deep soil.

According to a preferred embodiment of the invention, said deep soil is collected from the subsoil 1 meter below the ground.

According to a preferred embodiment of the invention, the preferred temperature for the second high temperature sintering is 1200° C.

According to a preferred embodiment of the invention, the preferred sintering time for said second high temperature sintering time is 8 hours.

Another purpose of present invention is to provide a quantum carrier capable of improving soil function by the aforementioned method.

According to a preferred embodiment of the invention, said quantum carrier can release far infrared light and the wavelength of said far infrared light is 4 to 14 μm.

According to the invention, said quantum carrier can produce negative ions.

According to the invention, said soil improvement functions include self-purification, increasing water content, increasing oxygen content, increasing protein content, adjusting pH value, pest elimination or promote microbial growth.

According to a preferred embodiment of the invention, said self-purification means elimination of the toxins in the soil, said toxins include heavy metals, pesticides, or chemical fertilizers, said heavy metals include cadmium, chromium or lead.

According to a preferred embodiment of the invention, said self-purification can further improve the quality of the produces grown in the soil; said quality improvement of the produces includes early harvest of the produces, prolonged flower preservation, extension of production period, increased yield, increased interval of fertilization application, delicate taste, reduced pests, no rotation required, increased immunity or toxin-free; said toxins include heavy metals, pesticides or chemical fertilizers; said heavy metals include cadmium, chromium or lead.

According to a preferred embodiment of the invention, said quantum carrier refers to organic fertilizers that used in common soil to replace fertilizers by spraying or mixing with common soil or the organic fertilizer that made of a quantum carrier for replacement of fertilizers; said fertilizers refer to organic fertilizers or chemical fertilizers.

According a preferred embodiment of to the invention, said quantum carrier can be mixed with edible materials and be processed to make feeds.

### BRIEF DESCRIPTION OF THE DRAWINGS

FIG. 1A shows the quantum carrier (1) sintering process whereby a bond and quantum carrier is generated.

FIG. 1B depicts particles of the oyster shell powder mixture containing a large amount of water and oxygen.

FIG. 1C depicts a sectional view of the particles of the oyster shell powder mixture.

FIG. 2 shows the electromagnetic spectrum wherein infrared 4-14 μm growth ray.

FIG. 3 shows vibrational jump and rotational jump of quantum carriers.

FIG. 4A shows the absorption effect of sintered oyster shell powder with a particle size of 40 mesh for 50 ppm cadmium (Cd), chromium (Cr) and lead (Pb).

FIG. 4B shows the absorption effect of sintered oyster shell powder with a particle size of 400 mesh for 50 ppm cadmium (Cd), chromium (Cr) and lead (Pb).

FIG. 5A shows the effect of the quantum carrier on lychee fruit with common fertilizers.

FIG. 5B shows the effect of the quantum carrier on lychee fruit.

FIG. 5C shows a comparison of quantum carrier effect on lychee plants of various maturity

FIG. 6A shows persimmon fruit fertilized with prior art chemical fertilizers.

FIG. 6B shows persimmon plant fertilized with common prior art fertilizers

FIG. 6C shows persimmon fruit fertilized with quantum carrier fertilizers.

FIG. 7A shows rice particles fertilized with common chemical fertilizers

FIG. 7B shows rice particles fertilized with an organic fertilizer made of quantum carrier fertilizers.

FIG. 7C shows the rear plant is the rice plant fertilized with an organic fertilizer made of quantum carrier fertilizers.

FIG. 8A shows lotus plant fertilized with common fertilizers. FIG. 8B shows lotus plant fertilized with quantum carrier.

FIG. 9 shows the effect of quantum carrier on cabbage. The left side is cabbage fertilized with common fertilizers. The right side is cabbage fertilized with quantum carrier fertilizers.

FIG. 10A shows rice plant fertilized with common fertilizers. FIG. 10B shows rice plant fertilized with quantum carrier fertilizers.

### DETAILED DESCRIPTION OF THE PREFERRED EMBODIMENT

The foregoing detailed description of the invention and the specific examples are provided herein for the purpose of illustration of the preferred embodiments only, and does not limit the scope of the claims.

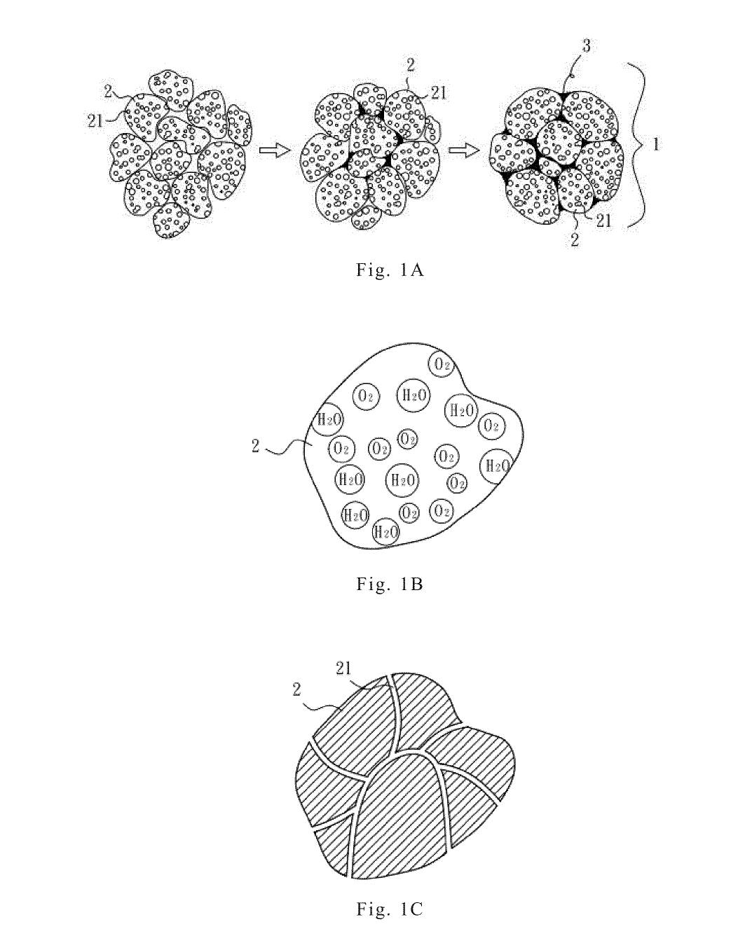

Now referring to the drawings, FIG. 1A shows the quantum carrier (1) sintering process, particle (2) dispersion of the oyster shell powder mixture before sintering, the particles of the oyster shell powder mixture have pores (21), particles begin to aggregate during the sintering process and form a bond (3) and generate the quantum carrier (1).

FIG. 1B depicts particles of the oyster shell powder mixture contain large amount of water and oxygen.

FIG. 1C depicts the sectional view of the particles of the oyster shell powder mixture.

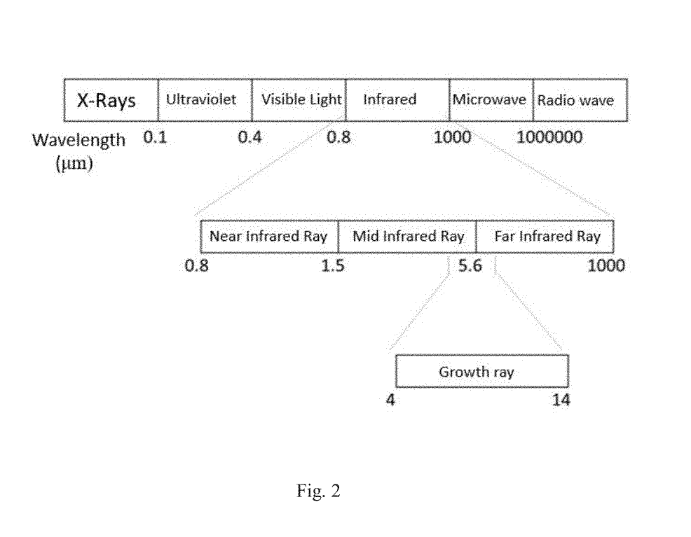

FIG. 2 shows the range of the electromagnetic spectrum in order to identify the range wherein the growth rays fall. The growth ray range is infrared 4-14 μm.

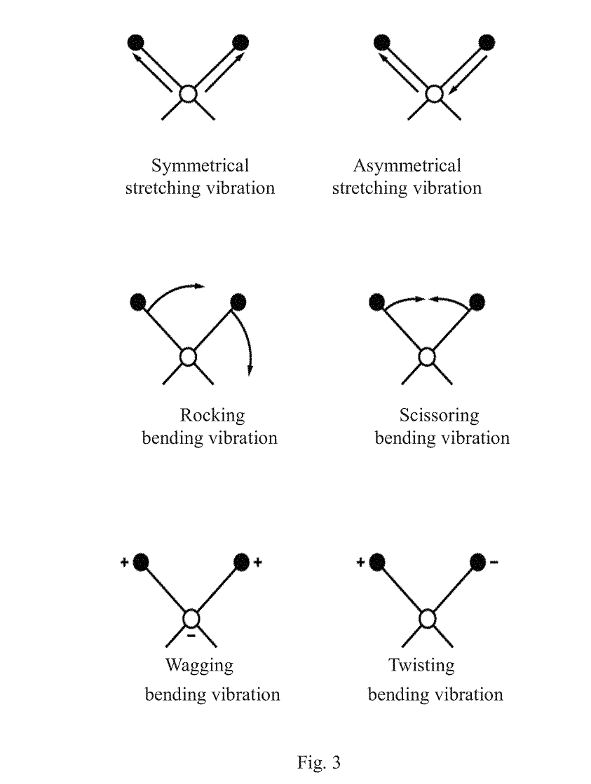

FIG. 3 shows vibrational jump and rotational jump of quantum carriers.

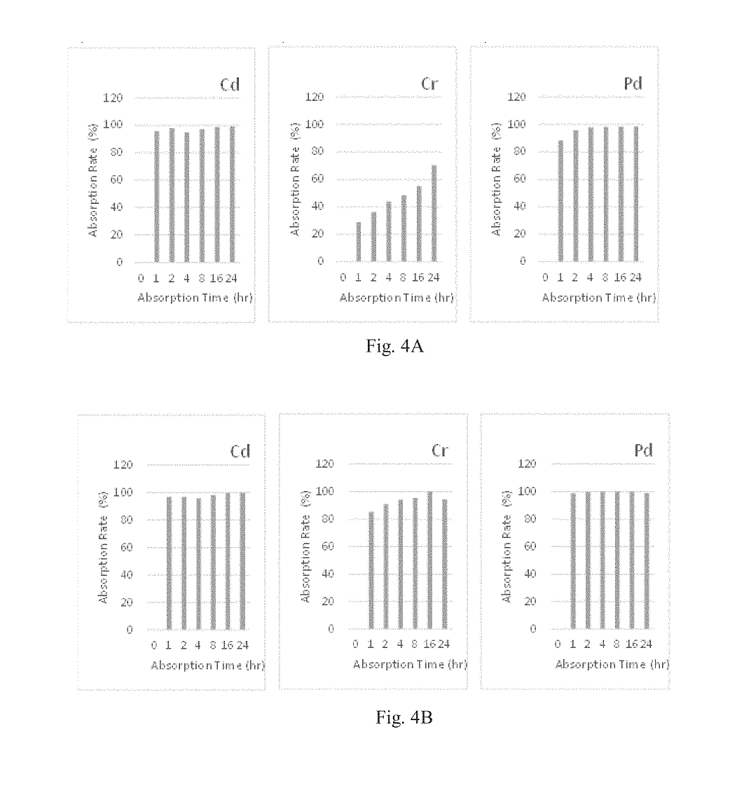

FIG. 4A shows the absorption effect of sintered oyster shell powder with a particle size of 40 mesh for 50ppm cadmium (Cd), chromium (Cr) and lead (Pb).

FIG. 4B shows the absorption effect of sintered oyster shell powder with a particle size of 400 mesh for 50ppm cadmium (Cd), chromium (Cr) and lead (Pb).

### EXAMPLE 1

### Preparation of the Quantum Carrier

The process for making quantum carrier according to the present invention is conducted in the following steps:

Step 1: Clean and remove the dirt and salt on the surface of the oyster shell with water, crush the shell to particles with a diameter less than 1 cm, sintering the crushed oyster shell at a high temperature of 800° C.˜1300° C. for 2 hours, the preferred sintering temperature is 1200° C., the pH of the sintered oyster shell powder is 8.59, the powder is dried and grounded to particles with a diameter between 40 mesh and 400 mesh to give sintered oyster shell powder.

Step 2: Mix the sintered oyster shell powder, diatomaceous earth and deep soil to make the oyster shell powder solid mixture; said oyster shell powder solid mixture is then mixed with water to making an oyster shell powder liquid mixture, said oyster shell powder liquid mixture consisting of one part of the oyster shell powder solid mixture and 30 parts of water.

Step 3: The oyster shell liquid mixture is subjected to high temperature sintering, said second high temperature sintering is liquid sintering, the temperature is between 800 and 1300° C., the preferred sintering temperature is 1200° C., the sintering time is around 8 hours, and the product is honeycomb-like particles with a rough surface, the quantum carrier. The ingredients of the quantum carrier are shown in Table 1. The sintering temperature varies with the ingredients of the powder, for example, the sintering temperature for a powder containing high silicon content is 800° C. FIG. 1 is the schematic diagram of bond generation between particles during the sintering process. Pores are formed between particles after sintering, and because diatomaceous earth has greater porosity and therefore most of the pores of the sintered body are contributed by diatomaceous earth. The porosity of the sintered body is up to 66.2% and water or oxygen content is up to 85.7%. The ingredients of the quantum carrier are shown in Table 1.

TABLE 1
The ingredients of the quantum carrier

| | | | Magne- | | | |
|---|---|---|---|---|---|---|
| Silicon | Ferric | Aluminum | sium | Calcium | Potassium | |
| dioxide | oxide | trioxide | oxide | oxide | oxide | Other |
| SiO₂ | Fe₂O₃ | Al₂O₃ | MgO | CaO | K₂O | Others |
| 70% | 3% | 20% | 2% | 0.5% | 0.1% | 4.4% |

The raw material of the aforementioned quantum carrier, the oyster shell, can also be replaced by the shells of other shellfish.

### EXAMPLE 2

### Quantum Carrier Produces Negative Ions

The above process results in production of negative ions by the derived quantum carrier. In measuring the rate of negative ions generated by the quantum carrier, eight samples were measured 20 seconds apart. The results show the average amount of negative ions is 383 ion/cc.

### EXAMPLE 3

### The Quantum Carrier has Far Infrared

The quantum carrier is a honeycomb-like particle with rough surface and releases far infrared with a wavelength of 4-14 μm (as shown in FIG. 2), its radiation rate is 0.955 or more and is capable of vibrational jump and rotational jump (as shown in FIG. 3). The 4-14 μm wavelength of far infrared is closely associated with growth and development of organisms because the wavelength can produce resonance with organisms and be effectively absorbed and thus is also called the growth ray. Far infrared allows vibrational jump and rotational jump of the molecules of organisms after absorbing the far infrared and electrons acquire sufficient energy at the ground state and is capable of jumping to an excited state with higher energy and induce a series of beneficial biological effects.

### EXAMPLE 4

### Quantum Carrier Increases Microorganism Flora

The quantum carrier increase microbial flora by multiple ways. First, the pores of the quantum carrier can increase the water and oxygen content in the soil and improve the environment for proliferation of the indigenous bacteria; second, the 4˜14 μm far infrared released by the quantum carrier will generate resonance with phospholipids, proteins and carbohydrates on the cell membrane, and cells may produce two major biological effects after absorbing far infrared, i.e., the thermal effect and non-thermal effect. Thermal effect is the vibrational or rotational energy of the molecules of a tissue, the jump energy difference generates resonance with the energy of far infrared which subsequently induces magnetic resonance in the indigenous areas by physical actions and promotes growth of the indigenous microorganisms. In addition, the 4 to 14 μm far infrared rays released by the quantum carrier can also promote resonance between large groups of the water molecules which break the hydrogen bonds between water molecules and make large water molecules into small water molecules, the small water molecules can easily enter the cells or perform biochemical reactions and are easily used by microorganisms and promote microbial growth. Furthermore, the far infrared released by the quantum carrier can degrade organic materials at a temperature below 45° C., when compared with the high temperature of 70° C. for compost, the low temperature for quantum carrier helps retain protein activities for use by microorganisms and increase the microbial flora. Because the quantum carrier increases beneficial bacteria, the harmful bacteria will be reduced.

### EXAMPLE 5

### The Quantum Carrier Eliminates the Toxins in the Soil

The quantum carrier consists of sintered oyster shell powder and the oyster shell powder can absorb heavy metals and release far infrared after sintering, and said far infrared can break the chemical bonds of the heavy metals, pesticides or other toxins by energy resonance and achieve the function of elimination of the toxins in the soil. The water from the rain or irrigation system during the cultivation period generates resonance with the sintered oyster shell powder, which makes the water molecules smaller, increase biochemical reactions as well as further purifies the toxins in the soil.

As shown in FIGS. 4A-4B, a further feature of the sintered oyster shell powder is its efficacy in the elimination of heavy metals. Around 0.5 g of the sintered oyster shell powder with a particle diameter between 40 (FIG. 4A) and 400 (FIG. 4B) mesh was added separately to 100 ml of the standard solution of 50 ppm cadmium, chromium and lead and the absorption effect of the sintered oyster shell powder for heavy metals was measured at room temperature. Inflame atomic absorption spectrometry was used for measurement and the heavy metal absorption rate of sintered oyster shell powder was calculated.

The absorption effect of sintered oyster shell powder for cadmium. Sintered oyster shell powder with a particle diameter of 40 mesh (FIG. 4A) or 400 mesh (FIG. 4B) was added to 50 ppm cadmium standard solution. The 40-mesh sintered oyster shell powder absorbed more than 95% of the cadmium in the standard solution of 50 ppm cadmium in one hour and 99.5% of cadmium was absorbed in 24 hours, while the 400-mesh sintered oyster shell powder absorbed 99.9% of the cadmium in the standard solution of 50 ppm cadmium in 24 hours. The 400-mesh sintered oyster shell powder has the best absorbency for cadmium.

The absorption effect of sintered oyster shell powder for chromium. Absorption of chromium by the 40-mesh sintered oyster shell powder is time-dependent (FIG. 4A) and absorbed 30% and 70% of the chromium in the standard solution was absorbed in one hour and 24 hours, respectively, while the 400-mesh sintered oyster shell powder absorbed 85% of the chromium in the standard solution in one hour and 100% of chromium was absorbed in 16 hours (FIG. 4B).

The absorption effect of sintered oyster shell powder for lead. The 40-mesh sintered oyster shell powder absorbed 88% of the lead in the standard solution in one hour and 99% of lead was absorbed by the 400-mesh sintered oyster shell powder in 1 hour (FIG. 4B).

Such efficacy studies evidence sintered oyster shell powder absorption to thereby clear heavy metals in the soil. They further show an inverse proportional correlation between the diameter absorbency level. That is the smaller the diameter, the greater the absorbency thereof.

### EXAMPLE 6

### Quantum Carrier Reduces Pests

A yet further feature of the present invention includes the efficacy of diatomaceous earth of the quantum carrier composition, which can reduce pests through physical principles. Diatomaceous earth has a protrusion structure and will generate mechanical actions with each other when in contact with larvae and injure the insect body and eliminate the pests hiding in the soil or in the animal body and reduce damage.

### EXAMPLE 7

### Quantum Carrier Improves Soil Quality

A yet further feature of the quantum carrier according to the present invention is its eliminating clay formation reaction of aluminum to make stronger soil aggregates. A further advantage is the quantum carrier's capacity to quickly adjust soil pH by, for example, restoring acidified soil (pH4.84) to a neutral level (pH6.8).

### EXAMPLE 8

### Quantum Carrier Increases the Benefits of Agricultural Cultivation

Another feature of the quantum carrier itself is its numerous ionic minerals which support the development of crop roots; in addition, the properties of the quantum carrier such as increasing water and oxygen content as well as growth promotion all help improve the benefits of agricultural cultivation. Shown below, table 2 demonstrates the results of improving the agricultural cultivation benefits by the quantum carrier. The study group and the control group are compared between the same crops planted in the same region during the same period. Use of the quantum carrier has multiple effects on agricultural cultivation, such as early harvest of the produces, extension of flower preservation, prolonged production period, increased production period, increased interval of fertilization application, delicate taste, reduced pests, no rotation required, increased immunity or toxin-free. The production period refers to the period during which the produces can be harvested after maturation.

TABLE 2
Quantum carrier increases the benefits of agricultural cultivation

| | | | Control group |
|---|---|---|---|
| | Growth | Study group | (commercial organic |
| Crop | observation | (quantum carrier) | fertilizer) |
| Gerbera | Growing | 40~60 days (use of additives | 120~180 days |
| | state | for 3 years) | |
| | Product | Flower preservation extended | General |
| | effectiveness | for additional 7~10 days | |
| Lotus | Growing | Harvest 15 days earlier (use of | general |
| | state | additives for 3 years) | |
| | Product | Production period extended | General |
| | effectiveness | for additional 30 days | |
| Rice | Growing | Harvest 14 days earlier (first | general |
| | state | time use) | |
| | Product | Rice milling rate: 75% | Rice milling rate: 60% |
| | effectiveness | | |
| Green | Growing | Overcome continuous cropping | Bacterial infection is |
| onion | state | obstacle (first year after use) | serious, rotation |
| | | | required |
| | Product | Loss rate caused by bacterial | Loss rate caused by |
| | effectiveness | infection: 2% (first time use) | bacterial infection: |
| | | | 30% |
| Ginger | Growing | Overcome continuous cropping | Bacterial infection is |
| | state | obstacle (four years after use) | serious, rotation |
| | | | required |
| | Product | The body of ginger is large and | General |
| | effectiveness | crisp and more spicy | |
| Green | Growing | 4~5 kg/per plant (four years | 1.5~3 kg/per plant |
| mustard | state | after use) | |
| | Product | Sweet taste, fresh with less | general |
| | effectiveness | fiber | |
| Corn | Growing | Harvest 14 days earlier (3 years | general |
| | state | after use) | |
| | Product | Thin skin, juicy and can be | general |
| | effectiveness | eaten raw | |
| Tea | Growing | Short leaf stem, juicy and shiny | Leaves and stems are |
| | state | leaves | thin, long and dull |
| | Growing | | |
| | state | | |
| | Product | Tea is not aged and 3 to 5- leaf | One-tip two-leaf can |
| | effectiveness | can be harvested | be harvested |

### EXAMPLE 9

### Efficacy for Growing Lychee Trees in Taiwan

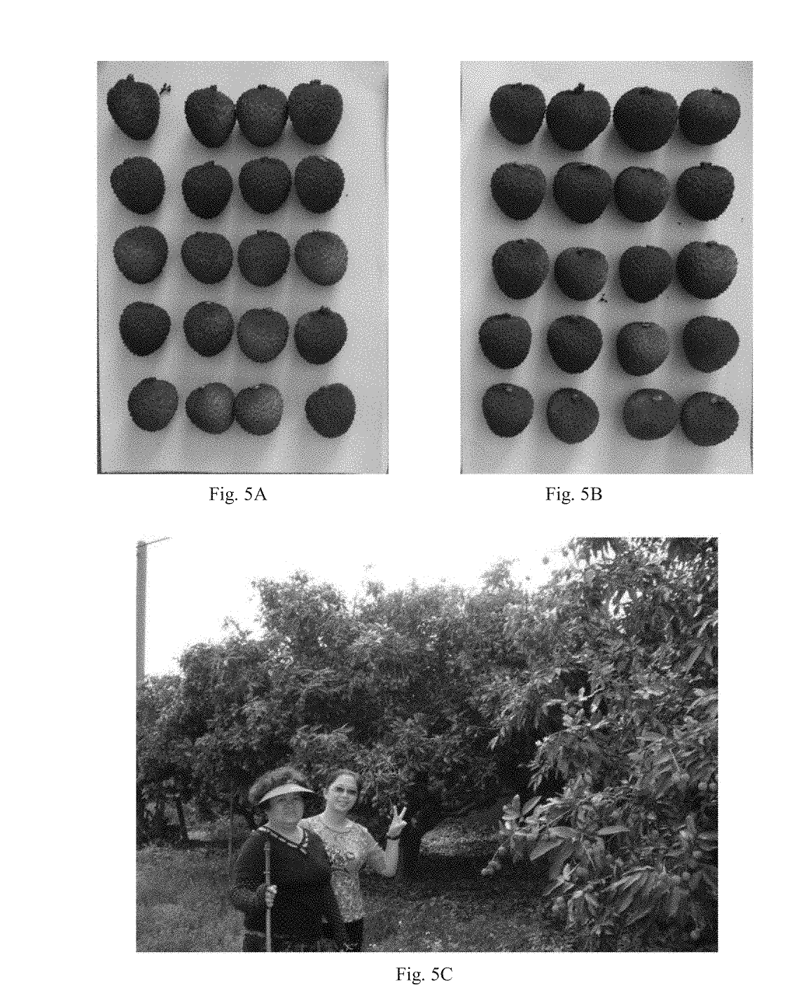

Now referring to FIGS. 5A-5C, the impact of quantum carrier fertilizers on lychee trees is shown. FIG. 5A shows the effect of the quantum carrier on lychee fruit with common, prior art fertilizers, which comprises the control group in the following efficacy study. The study group and control group are the lychee trees planted in the same farm during the same period.

Control group: use common chemical fertilizers, the fruits are not matured and still in green (FIG. 5C front plant). Study group: Apply the quantum carrier, the quantum carrier was directly sprayed onto the land in which the lychee trees are growing, one-time application, the fruit trees are healthy (FIG. 5C rear plant), the trunk and leaves were not withered and yellow and no signs of insect bites or diseases, harvested 14 days earlier, the fruit, compared with control group (FIG. 5A), is red and in rounded shape and tasted thick and juicy (FIG. 5B). The fruit trees treated with the quantum carrier are healthy, can be harvested earlier and the fruits taste better when compared with those treated with common fertilizers.

### EXAMPLE 10

### Efficacy for Growth of Persimmon Trees in Taiwan

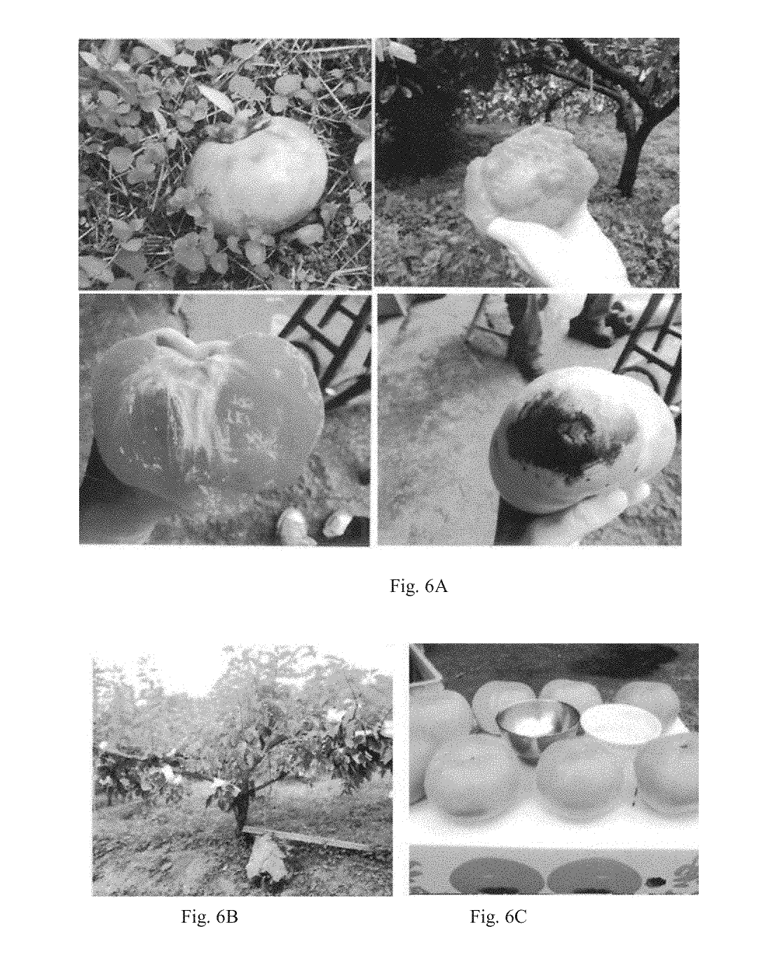

FIGS. 6A-6B shows the results of persimmon planting. The persimmon trees in the persimmon orchard were infected with anthrax and the soil pH was 4.8. Control group: treated with common commercial fertilizers, soil pH was maintained at 4.8, many fruit trees were infected. The fruit tree in the FIG. 6B is infected with Anthrax, the trunk and leaves appear black and scorched, and cracks, dents as well as spots are found on the harvested persimmons. The study group: Spraying the quantum carrier, the quantum carrier was directly sprayed onto the land in which the persimmon trees are planted, one-time application, soil pH was increased to 6.8. The fruit trees are healthy with improved immunity, the anthrax-infected plants were recovered and the shape of the fruits is intact without spots (FIG. 6C). The fruit trees treated with the quantum carrier are healthy and the shape, quality as well as production yield of the persimmons all showed improvements when compared with the plants treated with common fertilizers (FIG. 6A). The study group and control group are the persimmon trees planted in the same farm during the same period.

### EXAMPLE 11

### Efficacy for Growing Rice in Taiwan

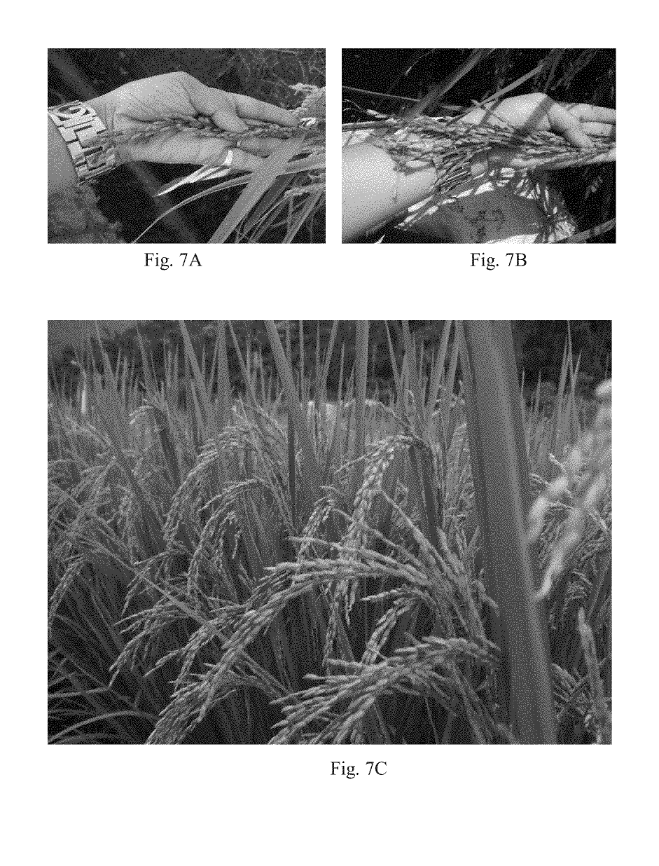

FIGS. 7A-7C shows the efficacy of the present invention on rice. The control group: shown in FIG. 7A, treated with common commercial fertilizers, in addition to application of the fertilizer before planting, both the fertilizers and pesticides were applied 3 more times before harvest. The rice was harvested 150 days after planting and the rice straw was brown and dropping and the rice grains were more yellow and the rice milling rate was 60%. The study group shown in FIGS. 7B and 7C: application of 500 kg of the organic fertilizer made of the quantum carrier onto one hectare of paddy field, the organic fertilizer made of the quantum carrier was directly sprayed as the common fertilizers before planting the rice, but the fertilizer and pesticides were not applied after the first application and before harvest. Referring to FIG. 7B, harvested 123 days after planting, the rice straw remains green and upright and the spike of rice is longer. In addition, the rice grains are full without black spots and the rice milling rate was over 75%. The rice treated with the quantum carrier was harvested 17 days earlier (18%), the rice plants were healthier on the date of harvest, and rice grains were full, yielding an increased rice milling rate of 25% when compared with the rice plants treated with common commercial fertilizers. The study group and control group are the No. 10 rice planted in the same farm during the same period.

### EXAMPLE 12

### Efficacy for Planting Lotus in Taiwan

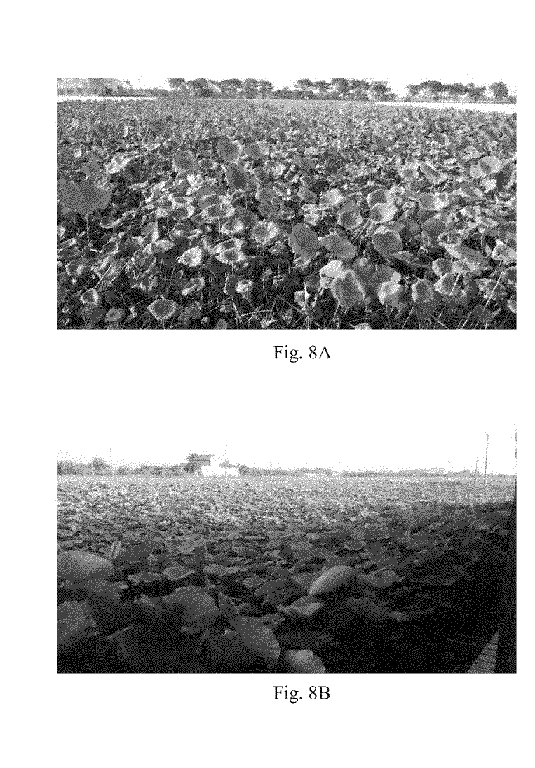

FIGS. 8A-8B demonstrates the results of planting lotus. Lotus plants are grown hydroponically. Referring to the control group shown in FIG. 8A: chemical fertilizers were added to the lotus plants and the roots of the lotus were seriously ill, dry and part of the stems and leaves were rotted during the post-harvest period after harvesting the lotus seeds. Referring to the study group in FIG. 8B: addition of the organic fertilizer made of quantum carrier to the pond with planted lotus plants, one application per year for a total of 3 years. During the post-harvest period, the stems and leaves were healthy without diseases after harvesting the lotus seeds. The lotus seeds grown on the arable land treated with the quantum carrier for 3 years were harvested 15 days earlier, and the production period of lotus seed was 30 days longer than the control group. The lotus plants treated with the quantum carrier were healthier without root rots and the lotus seeds were harvested 15 days earlier and the production period of lotus seed was 30 days longer when compared with those plants treated with common commercial fertilizers. The study group and control group are lotus plants planted in the same farm during the same period.

### EXAMPLE 13

### Efficacy for Planting Cabbage in Taiwan

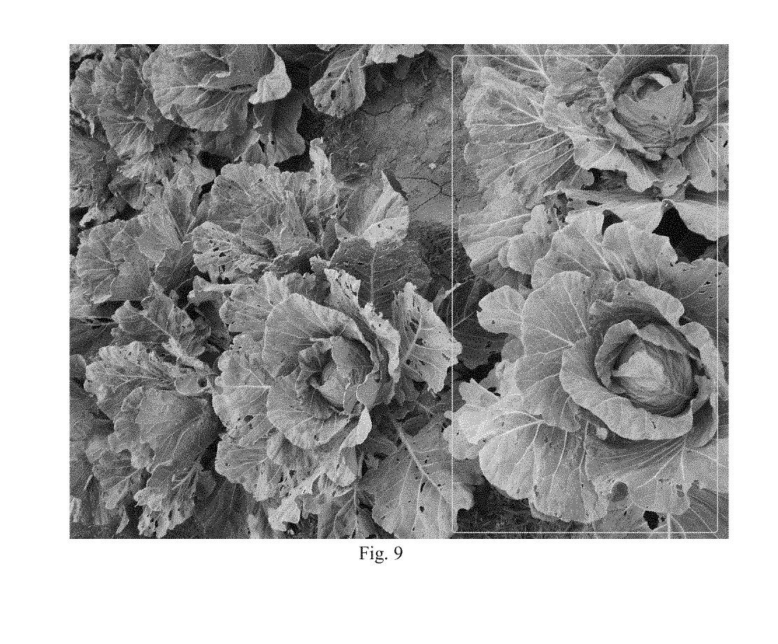

FIG. 9 demonstrates the efficacy of the present invention on the growth and leaf quality of cabbage. The control group fertilized by prior art mixtures is pictured on the left shows more diminished leaves smaller and numerous insect bites as compared to the study group on the right of FIG. 9, which was sprayed with the quantum carrier. The quantum carrier was directly sprayed onto the land in which the cabbaged was planted. As a result, the leaves were larger, thicker and stronger and contain minimal holes from insect infestation. The study group and control group are cabbages planted in the same farm during the same period.

### EXAMPLE 14

### Efficacy for Planting Rice in Taiwan

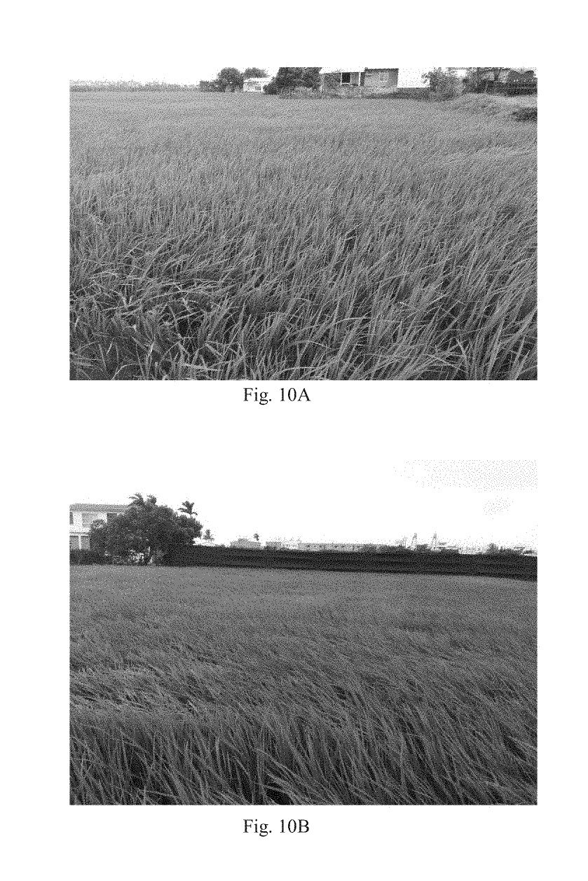

FIGS. 10A-10B evidences the efficacy of the quantum fertilizer according to the present invention on planting rice. First referring to the control group shown in FIG. 10 planted by using conventional farming and commercial fertilizers applied before and also 3 times after planting and before harvest, the plants are nonetheless less thick, strong and bear a yellow tone, and the yield tilled was less than the study group treated with the quantum carrier fertilizer shown in FIG. 10B., even though the organic quantum carrier fertilizer was only directly sprayed once, before planting the rice. Both of the fertilizer and pesticides were not applied after the first application and before harvest. As shown, the plants were healthy with greener color, tillering was initiated earlier when compared with the control group and the leaves, the production yield showed an increase of 8% even though harvest was performed 14 days earlier than in the control group. Moreover, examination of the harvested rice for pesticides indicated zero detection of 251 pesticides. Tillering is a rice growing state, the main stem will tiller during the stage of tillering, the earlier the tillering is initiated, the more leaves the tillers have and the higher the possible of forming the spikes. The study group and control group are rice plants planted in the same area during the same period.

### EXAMPLE 15

### Efficacy in Feed for Pigs

Further efficacy was evidenced in comparative study of pigs fed with edible mixtures container quantum carrier. The quantum carrier was mixed with edible materials and then processed to make quantum carrier feed for feeding the pigs, as set forth in the inspection report issued by Inspection & Quarantine Technology Centre, Henan Entry-Exit Inspection & Quarantine Bureau of P.R. China. The control group: common feed was used; the study group: the quantum carrier feed was used, a total of 117 pigs were included in the experiment. The pigs in the study group were energetic, agile and steady and had wide back and round hips and a shiny coat, and their disease resistance and immunity were better than the control group. Moreover, because the feed conversion rate was high, the exhaust is low and thus feces, filth and smell of the hog ring were significantly less when compared with the control group. The average weight of the pigs in the study group was 44.65 kg and the pigs in the control group gained an average weight of 39.85 kg. The feed conversion ratio of the study group and the control group was 1:2.55 kg and 1:2.93 kg, respectively. The meat percentage of the study group and the control group was 72.9% and 70.01%, respectively. The pigs in the study group were healthy and use of additional antibiotics or growth hormones was not required. In addition, no Lenobuterol hydrochloride (Clenbuterol), Ractopamine, salbutamol, Chloramphenicol, stilbestrol, Dienestrole, Hexestrol, Aureomycin, ivermectin was detected in the urine of these pigs ; no mercury, lead, arsenic, cadmium, chromium, Fwmepuine, Leucomycin, Lincomycin, Sarafloxacin, stilbestrol, Dienestrole, Hexestrol, Estradiol, 19-nortestosterone, dehydrotestosterone, Prednisolone, Methylprednisolone, melengestrol, Minigest, Medroxyprogesterone, 17-α-hydroxy progesterone was detected in the specimens of the meat.

1. A method for preparation of a quantum carrier for improvement of soil functions, comprising of the following steps:
(1) Pre-sintering treatment: after cleaning the oyster shell, crush the oyster shell and prepare a crushed oyster shell;
(2) First high temperature sintering: the crushed oyster shell is subjected to the first high temperature sintering, the sintering temperature is 800˜1300° C. and the sintering time is 1.5˜2.5 hours;
(3) Preparation of sintered oyster shell powder: the crushed oyster shell was grounded to sintered oyster shell powder after the first high temperature sintering;
(4) Mixing of the sintered oyster shell powder, diatomaceous earth and deep soil to make oyster shell powder solid mixture; said oyster shell powder solid mixture is then mixed with water to give an oyster shell powder liquid mixture, said oyster shell powder liquid mixture is consisting of one part of oyster shell powder solid mixture and 25˜35 parts of water;
(5) Second high temperature sintering: the oyster shell powder liquid is subjected to the second high temperature sintering, the temperature is 800˜1300° C. and the sintering time is 7˜9 hours to give honeycomb-like particles with rough surface, the quantum carrier.

2. The preparation method as recited in claim 1, wherein the diameter of the crushed oyster shell particles is less than 1 cm.

3. The preparation method as recited in claim 1, wherein the preferred temperature and sintering time for the first high temperature sintering is 1200° C. and 2 hours, respectively.

4. The preparation method as recited in claim 1, wherein the diameter of the sintered oyster shell powder is between 40 mesh and 400 mesh.

5. The preparation method as recited in claim 1, wherein the preferred diameter for the sintered oyster shell powder is 400 mesh.

6. The preparation method as recited in claim 1, wherein the solid mixture is consisting of 8˜12% of the sintered oyster shell powder, 8˜12% of diatomaceous earth and 76˜84% of the deep soil.

7. The preparation method as recited in claim 1, wherein the solid mixture is consisting of 10% of the sintered oyster shell powder, 10% of diatomaceous earth and 80% of the deep soil.

8. The preparation method as recited in claim 1, wherein the deep soil is collected from the subsoil 1 meter below the ground surface.

9. The preparation method as recited in claim 1, wherein the preferred temperature for the second high temperature sintering is 1200° C.

10. The preparation method as recited in claim 1, wherein the preferred sintering time for the second high temperature sintering is 8 hours.

11. A quantum carrier with soil-improving functions prepared by the method recited in claim 1.

12. The quantum carrier as recited in claim 11, wherein the quantum carrier can release far infrared; the wavelength of said far infrared is 4-14 ∞m.

13. The quantum carrier as recited in claim 11, wherein the quantum carrier can produce negative ions.

14. The quantum carrier as recited in claim 11, wherein the soil-improving functions include self-purification, increasing water content, increasing oxygen content, increasing protein content, adjusting pH value, pest elimination or promotion of microbial growth.

15. The quantum carrier as recited in claim 11, wherein the soil-improving functions include self-purification providing elimination of the toxins in the soil; said toxins include heavy metals, pesticides or chemical fertilizers.

16. The quantum carrier as recited in claim 11, wherein the soil-improving functions include self-purification thereby improve the quality of the products grown in said soil; the improved quality of the products includes early harvest of products, prolonged preservation of flowers, extended production period, increased yield, increased interval of fertilizer application, delicate taste, reduced pests, no rotation required, increased immunity or toxin-free.

17. The quantum carrier as recited in claim 15, wherein the heavy metals include cadmium, chromium or lead.

18. The quantum carrier as recited in claim 16, wherein the toxins include heavy metals, pesticides or chemical fertilizers; said heavy metals include cadmium, chromium or lead.

19. The quantum carrier as recited in claim 11, wherein the quantum carrier is directly sprayed, mixed with common soil or directly used to replace common soil or organic fertilizers made of the quantum carrier as the fertilizer, said fertilizer refers to organic fertilizers or chemical fertilizers.

20. The quantum carrier as recited in claim 11, wherein the quantum carrier can be mixed with edible materials and then processed to make feed.
